(19) United States
(12) Patent Application Publication
(10) Pub. No.: US 2009/0121026 A1
(43) Pub. Date: May 14, 2009

(54) PALM-BACK SUPPORT AND A TOOL SUPPORTED BY

(75) Inventors: Orit DRUKER, Holon (IL); Shimon SEACHUGA, Givataim (IL)

Correspondence Address: LOWE HAUPTMAN HAM & BERNER, LLP, 1700 DIAGONAL ROAD, SUITE 300, ALEXANDRIA, VA, 22314, US

(73) Assignee: SCANTASK LTD., Lehavim (IL)

(21) Appl. No.: 12/033,675

(22) Filed: Feb. 19, 2008

Related U.S. Application Data
(63) Continuation-in-part of application No. PCT/IL2006/000968, filed on Nov. 8, 2007.
(60) Provisional application No. 61/002,206, filed on Nov. 8, 2007.

(51) Int. Cl. G06K 7/10

(52) U.S. Cl. 235/462.44

(57) ABSTRACT

A palm-back support (201) is disclosed, for supporting a tool (207), (211) on the back-side of a user's palm. The palm-back support comprises (i) at least one finger loop member (202) configured to be worn on at least one of non-thumb user's fingers; (ii) a wrist strap (203) configured for wrapping at least partially a user's wrist; (iii) a support member (201) attachable to the backside of the user's palm by means of the finger loops (202) and the wrist strap (203) such that the user's palm (i.e. its inner side which is not shown in the Figs.) remains exposed, free of attaching elements in its entirety from the wrist to the base of the fingers. A tool attachable to or constituting a part of the palm-back support is also disclosed. Further disclosed is a method for attaching a tool to the backside of a user's palm, comprising; providing a palm-back support member for supporting the tool on the backside of the user's palm; providing means for holding a first end of the support member attached to a user's wrist; and providing means for holding a second end of the support member attached to at least one non-thumb user's finger, thereby leaving the users palm free in its entirety between the wrist and the base of the fingers.

### FIELD OF THE INVENTION

The present invention is in the field of wearable support and attachment devices for code readers.

### BACKGROUND OF THE INVENTION

Recently there have been built machine-code reading devices to be used in conjunction with Handheld Mobile Communicators, as cellular and/or WAN enabled PDAs, phone handsets, etc., herein after HMCs. Those machine-code reading devices are mechanically attachable to particular models of said HMCs and/or to their connector ports e.g. SD I/O card, etc.. The attachment arrangements between the code readers and the HMCs constrain and involve ergonomic problems such as unnatural user's hand position at work, as well as mechanical robustness problems, two most critical drawbacks when analyzing mobile workers' needs.

Harnessing devices for attaching code readers to the hands, palm or fingers of a user are available in the market. Such harnessing devices include attaching straps or glove portions across the user's palm, and/or cables extending between a reader and its control terminals.

### SUMMARY OF THE INVENTION

The present invention relates to a palm-back support for supporting a tool on the back-side of a user's palm, comprising (i) at least one finger loop member configured to be worn on at least one of non-thumb user's fingers; (ii) a wrist strap configured for wrapping at least partially a user's wrist; (iii) a support member attachable to the backside of the user's palm by means of the finger loop and the wrist strap such that the user's palm remains exposed in its entirety from the wrist to the base of the fingers, i.e. free of attaching elements such as straps or glove portions in its entirety from the wrist to the base of the fingers.

The palm-back support may optionally be provided with loops' length adjusting mechanism in order to enable adjusting the loops lengths thereby allowing for enhanced adaptation of the support to different hand sizes. Said adjusting capability may further facilitate wearing the support on a gloved hand, and on hands having radically irregular fingers' circumferences. The palm-back support may optionally be provided with a strap's distance adjusting mechanism configured to allow adjustment of the distance of said support member from a user's wrist, thus adapting the palm-back support to hands of different sizes, or to gloved hands.

The support member may be interconnected between or form an integral unit with the finger loop and the wrist strap.

According to some embodiments of the invention the support member is configured to either accommodate, hold, or serve a housing for at least a portion of components constituting an adjusting mechanism for adjusting the loops' lengths or for adjusting the distance from the wrist strap.

According to some embodiments of the invention the support member is a part of a housing of the tool to be supported on the palm's back-side.

In some preferred embodiments the support member of the palm-back support comprises a pouch configured to removably accommodate the tool in an operative position on the back of the palm. Straps, stretchy strips or the like may be configured for holding and/or tying the tool to the support member as an alternative to a pouch. These and other options for maintaining a tool attached to the support member will become more apparent after reading the remaining description.

According to other various embodiments of the invention the support member comprises a first connector configured to be connectable to a second connector, said second connector being part of or attachable to said tool, thereby enabling to removably attach the tool to the support member by connecting the first and second connectors to each other.

The invention further relates to a tool either attachable to, insertable into or constituting a part of the palm-back support. According to some preferred embodiments the tool is removably insertable into a full or partial pocket-like compartment built as part of the support member, for holding the toll in an operative position on the support member.

According to some other preferred embodiments the tool comprises attachment arrangement or connector configured to allow for removably attaching the tool to the support member.

According to some additional preferred embodiments said tool and a built-in attachment arrangement or connector thereof constitute a kit with the support member and with a separate independent mobile handgrip to which the tool may be removably attached as an alternative to its attachment to the support member. This feature of the invention provides a user with the choice of working with the tool attached to his palm's backside or alternatively working with the same tool without harnessing the tool to his hand, rather attached to a mobile handgrip, preferably having an ergonomic design. According to some embodiments the mobile handgrip comprises an extension rod to an end of which the tool may be attached, thereby allowing for reaching out with the tool at locations remotely from the reach of a bare hand. In some of these embodiments the extension rod is telescoping, allowing to adapt the length of the extension per task requirements.

According to various embodiments the tool constitutes an electronic device configured for wireless communication with a remote electronic system.

According to various embodiments the tool is an electro-optic device configured for illuminating or for optically sensing optically readable information located in hard to reach places.

The electronic device may be for example a code reader capable of reading machine readable codes and transmitting data indicative of the read codes to a remote system.

The electronic device may be configured for reading at least one of the following code types: optical, magnetic, RF.

The electronic device may also be configured for communicating with a code carrying tag.

The electronic device is preferably configured for wireless communication with the remote system, via at least one of the following signal transmission types: RF, IR and acoustic signals.

According to various preferred embodiments of the invention the code reader is passive, constituting a slave governed by the remote system. The code reader may comprise, however, an ON-OFF switch for turning the reader on or off independently of the remote system.

An electronic code reader may be configured according to the present invention to utilize the accomplishment of a successful code reading for automatically triggering the activation of a successive code scanning. Such successive code scanning may be with a programmable or a predetermined delay between successive code scans.

The invention further relates to a method for attaching a tool to the backside of a user's palm, comprising; providing a palm-back support member for supporting the tool on the backside of the user's palm; providing means for holding a first end of the support member attached to a user's wrist; and providing means for holding a second and of the support member attached to at least one non-thumb user's finger, thereby leaving the users palm free in its entirety between the wrist and the base of the fingers.

Some embodiments of the tool will now be disclosed. Making use of the palm back support according to the present invention may provide for a low cost wearable, fast attachable, and Wireless (e.g. using Bluetooth or ZigBee, or UWB, IR, etc. wireless communication means and standard protocols, herein after Short Range Wireless Communication, SRWC), Slave Reader module herein after WSR configured for barcode reading, RFID reading, camera recognizable character reading, etc.) the mechanical shape of which is independent of (i.e. need not be influenced by) the mechanical shape (i.e. outer design) or the physical or electrical design of connectors of the HMC controlling it. Also, the invention provides for a stand-alone palm-back harness useful for supporting the housing of a wireless slave reader module on the back of a user's palm, which is useful for fast positioning and removal of wireless slave reader modules onto and from the backside of a user's palm.

Preferably, a WSR device according to the invention comprises a low cost functional set of minimal electronics for enabling users of commercial SRWC enabled Handheld Mobile Communicators, as cellular and/or WAN enabled PDAs, phone handsets, etc., herein after HMC, as well as any other computer system, to read, collect and transmit machine readable codes as of barcode, RFID tags, magnetic tags, NQR (Nuclear Quadropole Resonance) RF tags, optical tags etc., herein after also ‘machine readable codes’, requiring no mechanical or wire connection between the WSR and the HMC.

The operation of the WSR according to the present invention is preferably a completely ‘slave mode of operation’, i.e. is completely dependent on the HMC in that it is incapable of independently collecting a machine readable code i.e. it cannot operate and fulfill a code collecting task without being coupled to an HMC as a master. The client software application of the HMC totally controls and manipulates the WSR through the SRWC channel (e.g. Bluetooth) according to its needs.

The housing of said low cost WSR is held in place on the palm-back of the user's hand by a flexible support wearable on the palm-back of the user's hand. In some embodiments of the invention, the housing comprises at least one finger loop to be worn on one or more of user's fingers and an adjustable band mechanism to be closed on or around the wrist region of the said hand.

Said WSR with a finger/s and wrist wearable support configuration according to the invention leaves the palm of the user free to perform any work including gripping of objects, tools, etc.

The WSR of the present invention in its preferred embodiments comprises fast attachment mechanism/s (comprising at least one attachment arrangement, connector or pouch) for fast positioning and removal of the said electronic WSR's housing to the said flexible support element/s in order to enable fast replacement of the said WSR for recharging purposes or defective unit replacement.

The said WSR further comprises the Slave Reader module electronics, which comprise a low cost functional set of minimal electronics allowing users of commercial SRWC enabled HMCs to read, collect and transmit machine readable codes, without any electrical or mechanical contact between the said WSR and HMC.

The said WSR communicates its code read data to a remote server through a software application running in the programming environment (Palm OS, J2ME, Windows CE, etc.) of the user's SRWC enabled HMC. The HMC's wireless network can be any of the well known types of Wireless WAN networks or cellular networks that support data connectivity like CDPD, GPRS, CDMA 2000, W-CDMA, CDMA 1×, etc. and is connected via a gateway to the Internet.

Apart from serving as the command control and communication platform of the WSR, the said SRWC enabled HMC serves also as the offline database and feedback terminal of the user using the said WSR. Provided they use the same SRWC, the WSR of the present invention can work with any new SRWC enabled HMC without any hardware or mechanical adaptations.

Modern personal communication devices, cellular PDAs, mobile phones, etc., are now SRWC enabled (e.g. Bluetooth), have large color screens, and are provided with relatively strong computing platforms—Palm OS, J2ME, Pocket PC, etc., and are available for all cellular data networks and the new ones also to wireless WAN network or a combination of both.

The present invention makes use of the said HMCs' communication, display, memory and computing capacities (herein after “terminal capabilities”) and provides a fast attachable wearable WSR, the mechanical shape of which is independent of the HMC's mechanical shape or of the physical or electrical design of connectors of the HMC. The WSR comprises a low cost functional set of minimal electronics allowing users of commercial HMCs to exploit the “terminal capabilities” and the bi-directional SRWC communication capabilities for reading, collecting and transmitting machine readable codes, without the need of electrical or mechanical contact between the WSR and HMC.

According to some embodiments of the present invention, the WSR comprises an electronic Slave Reader module held in place on the palm's back of a user's hand by a flexible support wearable on the palm's back of the user's hand by means of attachment members comprising (i) at least one non-thumb finger wearable loop made of a flexible material such as neoprene, EPDM, or the like., to be worn on one or more of user's non-thumb fingers by insertion of the finger/s trough the loop, and (ii) a flexible strap configured to be worn on the wrist region of the hand.

In some preferred embodiments the length of at least one non-thumb finger wearable loop is adjustable by a loop's length adjusting mechanism configured to allow modifying each of the loops' length to different hand sizes and to gloved hands of different sizes, and to various fingers' circumferences. Whether or not a loop's length adjusting mechanism is provided, a strap's length modifying mechanism for adjusting the distance from the wrist strap to the support member may be provided, for adaptation of the palm-back support to different hand sizes and for glove wearing hands.

Preferably, the invented palm-back support device utilizes flexible parts, e.g. flexible finger-loops and flexible wrist strap, thus making the wearable support more easily fit on users' palms of different sizes. It should, however, be understood that the invention is not limited to this specific configuration, and generally, certain parts of the support including the finger loops or the wrist strap might be formed rigid or semi-rigid. It should thus be appreciated that referring to the support as ‘flexible’ should not be held as a restriction to the thought and deserved scope of protection.

In some preferred embodiments the support member serves also as a housing for a length modifying mechanisms either for modifying the lengths of finger loops or of the distance from the wrist strap and is interconnected between said finger loop/s and the wrist strap.

The invention further relates to a tool attachable to, inserted into, or constituting a part of the palm-back support.

According to some preferred embodiments the tool is removably attachable to the support member by means of at least one connector, e.g. a clip like connector type, Velcro or scotch (micro clips) like connector type. In the context of this specification the term ‘scotch’ means ‘Velcro’.

According to some preferred embodiments the tool is removably inserted into a full or partial pocket-like compartment built as part of the support member.

According to some additional preferred embodiments said tool constitute a kit with a separate independent mobile handgrip with which a tool provided with a built in attachment provision may be removably attached as an alternative to its attachment to the support member. This feature of the invention provides a user with the choice of working with the tool attached to his palm's backside or alternatively working with the same tool attached to a mobile handgrip, preferably having an ergonomic design, i.e. without harnessing the tool to his hand. The handgrip may comprise an extension to an end of which the tool is attachable, thus allowing to bring the tool to code reading locations located beyond the reach of a bare hand. The extension member may be a plain rod, a telescoping rod, an accordion-like extending mechanism, or any other preferred extending arrangement.

According to various embodiments the tool constitutes an electro-optic device configured for sensing or illuminating in hard to reach places.

Such WSR wearable support configuration making use of user's finger/s and wrist for attachment, leaves the palm of the user substantially free to work, e.g. to grip objects or working tools, etc. This is in contrast with some support devices available in the market, in which straps or glove portions cross the inner side of the user's palm.

The non-thumb finger loop according to the invention can be shaped either elongated or as a ring, having inner circumference dimensioned for substantially matching the circumference of a non-thumb finger to be wearing it. According to various embodiments, the finger loop has inner circumference of a dimension greater than that of a finger to be wearing it, thus enable users of different palm sizes or users wearing work-gloves to wear the finger loop regardless of fingers' size, and regardless of the thickness of work-gloves if worn.

In accordance with various embodiments of the present invention the palm-back wearable support of the present invention further comprises adjusting mechanism for adjusting the length of the wearable support, e.g. by changing the distance between the Slave Reader module and the wrist strap e.g. by means of a buckle located on or near the strap or by means of a Velcro fastener. The adjusting mechanism is useful for increasing user's comfort or for adapting a wearable support of predetermined dimensions for use of users having different hand sizes and/or wearing gloves.

According to the present invention the WSR may further comprise fast attachment mechanism useful for facile replacement of the Slave Reader module connected to the flexible support, e.g. for recharging or e.g. for replacing a defective unit.

In a preferred embodiment the support is flexible and is built as a single piece including as integral parts a first half connector of the fast attachment mechanism and the adjusting mechanism (not including a second half connector being a counterpart of the first half connector of the fast attachment mechanism, which may be integral to a housing of the Slave Reader module).

The said fast attachment mechanism can be for example a bracket built as a part of the flexible support by a dual molding manufacturing process or optionally welded to it by ultrasound, glued, riveted, or otherwise integrated to it to form a first half connector matching a second half connector integrated to the housing of the electronic Slave Reader module (207), wherein the second half connector being a counterpart to the first, thus provided e.g. with matching dents for snap fixing it into the said bracket.

Optionally the fast attachment mechanism can be achieved by e.g. gluing, riveting or otherwise integrating any acceptable reclosable fastener patch/es (e.g. as 3M Dual Lock SJ4580) onto the flexible support and onto the housing of the Slave Reader module to enable a simple fast connecting/disconnecting mechanism between the two surfaces.

The present invention provides for a low cost wearable add-on device comprising an economic electronics capable of performing a minimum set of predetermined functions (such as: receiving turn-on and turn-off commands, reading a code, transmitting a code, distinguishing between successively read codes) that can be easily operated by mobile workers from their HMC handset or from a remote control read-switch, leaving their hands free to work similarly to the way they were working when dealing with their HMC handset alone. Alternatively the novel wearable reader of the present invention enables workers to hold the handheld mobile communicators in the same hand carrying the fast attachment WSR, thus providing full terminal capabilities in a single hand.

By having the WSR of the present invention attached on the palm's back of a user's hand, it becomes simple easy and natural pointing at a target to be read (for example in barcode reading application), since there is no need in flexing the wrist, and since the user's hand remains free for e.g. holding the HMC, picking a package, or performing any other operation.

Preferably, the WSR further comprising the Slave Reader module electronics, has a low cost minimal set of functional electronics useful for users of commercial HMCs such as SRWC enabled cellular and/or WAN enabled PDAs, phone handsets, etc., for reading, collecting and transmitting machine readable codes as of barcode, RF tags, magnetic tags, NQR tags, optical etc., requiring no electrical wiring nor mechanical contact between the WSR and the HMC.

The Slave Reader module of the present invention may comprise one or more reading engines capable of reading machine readable code as of barcode, RF tags, magnetic tags, NQR tags, optical etc., code readers According to some embodiments the said reading engine is an active device capable of communicating with said machine readable code carrying tag (e.g. for energizing it momentarily to respond by transmitting its specific temporal or/and frequency modulated code in RF (common used RFID frequencies or NQR (Nuclear Quadropole Resonant)) frequencies, or optical light frequencies e.g. a blinking LED. The code carrying tag may comprise its own energy source as well, so that the reading engine serves only for triggering the response of the code carrying tag and not for energizing it. The Slave Reader module further comprises a SRWC transceiver unit for communicating with the said SRWC enabled HMC user's device, a rechargeable battery and power management electronics, electronic computation means for controlling work protocols of the code reading engine/s, the SRWC transceiver unit, and the power means, and for regulating the communication with the said SRWC enabled HMC user's device, a power charging connector and an on/off switch.

Optionally the said Slave Reader module further comprises one or more LED indicators for indicating the work status of said predetermined functions.

The housing of the Slave Reader module preferably comprises a mechanical fast attachment mechanism allowing for connecting and disconnecting between the flexible support and the housing. In embodiments implementing a stand-alone flexible support, the fast attachment mechanism comprises a first half connector integrated with the housing matching a second half connector integrated with the support. In embodiments implementing a housing which itself being a part of the flexible support, the fast attachment mechanism comprises at least one half connector integrated with the housing matching a second half connector integrated with the finger loop or with the wrist strap.

According to some embodiments the electronic device constituting the tool is an active device capable of communicating with code carrying tag (e.g. for energizing it momentarily to respond in transmitting its specific temporal or/and frequency modulated code in RF (common used RFID frequencies or NQR frequencies) or Optical light frequencies or sound/ultrasound frequencies, etc. Alternatively said code carrying tag may comprise its own energy source so that said active device communicates with it for only triggering the response of said code carrying tag (and not for energizing it).

According to various preferred embodiment the code reader is a substantially passive device presenting a slave governed by the remote system. It may be provided however with an on-off switch mechanism allowing a user to turn the reader on or off directly. It may further be provided with a recharging circuit allowing a user to recharge a rechargeable power source powering the reader, independently of the remote system.

According to various embodiments the electronic device is located in a housing which is a part of said support member. Preferably, however, the housing includes or is connectable to a second connector configured to be connectable to a first connector of the support member, thereby enabling to removably attach the tool to the support member by connecting the first and second connectors to each other.

The invention relates also to a method for attaching a tool to be used by user to user's hand in a manner allowing the user to selectively use said tool while having his hands free for other work, the method comprising: providing a palm-back support structure configured to be removabaly attacheable to the user's palm, wherein said palm-back support structure is configured to connecting said tool thereto. Preferably the support structure is removabaly attacheable to the user's palm by inserting at least one of user's fingers into a non-thumb finger-loop of the support structure and by wrapping at least part of the circumference of user's wrist by a wrist strap of the support structure.

In the preferred embodiment the said WSR communicates its code read data to a remote server through a software application running in the programming environment (Palm OS, J2ME, Windows CE, etc.) of the user's SRWC enabled HMC. The HMC's wireless network can be any of the well known types of Wireless WAN networks or cellular networks that support data connectivity like CDPD, GPRS, CDMA 2000, W-CDMA, CDMA 1×, etc. and is connected via a gateway to the Internet.

Apart from serving as the command control and communication platform of the WSR, the said SRWC enabled cellular and/or WAN handset (HMC) serves also as the offline database and feedback terminal of the user using the said WSR. Provided they use the same SRWC, the WSR of the present invention can work with any new SRWC enabled HMC without any hardware or mechanical adaptations.

It should be emphasized that any future SRWC technology that will be commonly integrated (built in or custom made on SD I/O card or other snap in electronic module) into HMC devices such as cellular phones, PDAs, Tablet PC, etc., is also in tone with the present invention and can be easily implemented to be used in our system, thus included in the requested scope of protection. As those HMC devices will be provided with SRWC communication means like the present Bluetooth, IR, or the near future ZigBee, Wi-Fi (IEEE 801.11), UWB, or ultrasound communication means, corresponding SRWC enabled WSR will be easily build to communicate with those HMCs.

For example we can already point at the ZigBee chip from Oki Ltd. & CompXs Inc., the AT86RF210 from Atmel (Z-Link chip set), the MC13191 and MC13192 from Freescale, and others that are now in final development stages. As regarding evolving UWB solutions we can already mention the Direct Sequence UWB XtremeSpectrum chipset of Freescale (Motorola) and the Multi-Band OFDM solution developed by companies as Wisair, Alereon and Staccato Communication expected to emerge on market by the end of 2005.

The user who uses the said SRWC enabled cellular and/or WAN handset ((built in or add-on SRWC system (e.g. on an SD I/O card)), can choose and control the WSR reading application, for activating the code reading session via a software defined button of the said HMC.

The local computing platform and software application of the said HMC is configured to enable the user to continue reading codes and receive critical feedback even when server or cellular connectivity are interrupted for any reason. The user can also make or answer a phone call and The system is preferably configured to return automatically to the WSR application after the end of the a call session, so as to allow the user initiating or answering a phone call in the middle of his work with the WSR.

Optionally a WAP system is also in the scope of the present invention even though the Wireless Application Protocol does not allow storing the current operational status locally in the handset, or providing feedback to the user, which makes it useless in an interrupted communication scenario.

It is a favorable outcome of the present invention that the said WSR can be “worn” on the same hand that holds the said HMC device (602), which together with the said “terminal capabilities” and the dedicated HMC's client application software (written in Palm OS, J2ME, Windows CE, etc. depending on the device's software platform), enables to read codes, input data and receive feedback to the said HMC, thus transforming the said two device system into a powerful “virtual terminal” with greater capabilities than most of the existing cellular/WAN integral terminals and at a fraction of their cost.

Furthermore, upgrading existing conventional terminals with new or additional reading sensors can be made only by replacement of the whole system. This is in contrast to the system of the present invention which can be easily and economically upgraded by only replacing the low cost WSR unit.

According to a preferred embodiment the user's system comprises a Bluetooth (SRWC) enabled smart cellular phone such as the J2ME enabled Motorola E398 cellular phone, or cellular and Bluetooth enabled PDA as the Windows CE enabled XDA II of HTC, a software client set of applications, a data wireless network which provides access to Internet over a TCP/IP protocol like HTTP and a server system accessible over the Internet. According to the present invention the WSR comprise a low cost functional set of minimal electronics enabling the user of said cellular devices, HMCs, to read, collect and transmit machine readable codes such as of barcode, RF tags, magnetic tags, NQR tags, optical etc., the operation of the WSR of the present invention being completely a ‘slave mode of operation’, i.e. is completely dependent on the HMC in that it is incapable of independently collecting a machine readable code i.e. cannot operate and fulfill a code collecting task without being coupled to an HMC as a master. The client software application of the HMC totally control and manipulate the WSR through the SRWC channel (e.g. Bluetooth) according to its needs. The application can trigger a code-reading operation in response to a system event like choosing a menu option or pressing a software defined button on the HMC. The software application is further capable to configure the WSR according to its needs by sending configuration commands. It can for example enable or disable the recognition of particular barcode symbology. The software application can enable or disable code reading in order to avoid unintentional reading operation during driving for example.

In an example of an operating embodiment, the client software runs on a commonly available HMC device with integrated SRWC Bluetooth port like that of a Nokia 6600 cellular phone. The client application connects to a server application by means of the cellular network, Intranets and Internet. A sample system configuration is discussed later in the description of the preferred embodiment.

The SRWC Bluetooth enabled WSR, of a preferred embodiment can make use of a commercial existing single chip wireless system that comprises in a single package a radio chip and a baseband chip, for example the BlueCore2-Rom or Flash from CSR, or the Vista module from Flextronics with integrated ARM7 core processor, or the ZV4301 Single-Chip Bluetooth Platform from Zeevo, or SiW3500 UltimateBlue from Silicon Wave/RF Micro-Devices, etc.

The WSR barcode reading can be implemented using the Intermec EV15 or EV12 scan engine or the Symbol SE 923HS or the 2D scan engine Symbol Se4400, or the 2D IT4000 from HHP, or similar barcode scan engines.

The system preferably includes a utility application to configure the WSR manually or with predefined configuration script from the server (useful for automatic configuration of multiple devices). The utility application runs on a personal computer and allows configuring different aspects of the WSR operation like disabling or enabling barcode symbologies or adjusting the way the barcode data is presented.

The system is preferably provided with a method for unambiguous connectivity with the WSR. It is possible that several WSR devices will thus be in the SRWC range of the handheld mobile communicator. An important feature of the method is that on its activation the software application running on the HMC (hereinafter mobile application) recognizes to which WSR to connect. The system is provide with a configuration mode of operation, during which the user may select the unique ID of the WSR device he intends to use. In the case of Bluetooth communication the unique ID of the WSR being encoded as UUID, natively supported by the protocol. After the user selects the correct ID among all available it will be stored in the persistent memory of the HMC. Once the UUID of the WSR is stored in the mobile application, the application will query for a device having that particular UUID. The said unique ID of the WSR can be its serial number that will be preferably printed on the device itself. According to various embodiments the system provides also for a recognition operation that enables the user to recognize the registered WSR among other WSR devices. In the case of a barcode WSR the recognition operation will activate barcode reading beam, optionally for a reduced time, thus enabling the user to see the registered WSR, or enable the blinking of a LED indicator on the WSR especially practical in case of a RF tag reader.

The system further provides means to monitor the status of a requested code-read operation from the mobile application. For example an audio signal may be generated for indicating to the user a successful code-read process. In order to make the client system operable in conditions of bad or no connection to the network, the said mobile application preferably contains the user interface data, some of the verification algorithms, the critical logical rules and forbidden sequences of activities (the system “is made aware” about those activities by the user's scanning of the respective codes representing those activities, e.g. placing a specific package into a specific truck or harvesting a specific parcel from a specific greenhouse) and part of the most important feedback data, thus enabling the user to perform part of the operations locally without communicating with the server. The system can cache application data in the persistent memory of the Handheld Mobile Communicator in order to enable the user to work offline for cases when connectivity with the server is lost.

In order to prevent unwanted code-read operations by unintentionally activating the WSR code-read function, the said client application can send (via the Bluetooth channel) an enabling (or disabling) command for the WSR (optionally by choosing from a menu or pressing a software defined button on the said PDA, phone, etc.). Once in an “enabled” work session the code-reading trigger of the WSR will be initiated and transmitted by the said client application by pressing a software defined button on the said personal communication device handset.

Optionally the code-read trigger to the WSR will be transmitted wirelessly from a Bluetooth enabled, battery operated, stand alone control switch to be held as a car alarm switch in the user's hand or attached to the user's clothes and activated by a touch, e.g. with the second hand. The said stand alone Bluetooth control switch can take a variety of forms, for example in a system that use a PDA as the HMC device, this switch can be built as a PDA pen.

In a modified embodiment, the said WSR code-read trigger for reading a particular code is generated by an activation-only mechanism, of making a substantial hand movement that changes the status of a sensor (e.g. motion sensor, optical sensor, acceleration sensor etc.) in the said WSR. One can use for example a tilt-switch CW 1300-1 from Assentech or a tilt-sensor D6B from Omron as the motion trigger. The said movement will only activate the read trigger and not stop it (an activation-only mechanism), so that the result of extra movements will not hamper the read process, the only drawback of a too much sensible sensor will be some extra battery consumption. The stop-read signal will be provided by the WSR's micro-controller after a preset time period of several seconds, the said time will be software programmable.

Optionally the said stand alone control switch will comprise a simple coded RF emitter e.g. a car alarm control, to be hold in the user hand or attached on the user's clothes and activated by a touch, e.g. with the second hand, wherein the WSR will be provided with an RF receiver, which received signal will be decoded by the WSR's microcontroller. Optionally the code-read trigger to the WSR will be transmitted wirelessly from an ultrasound enabled, battery operated, stand alone control switch comprising for example the Murata MA40S4S 40 kHz transmitter, wherein the WSR will be provided with the MA40S4R receiver for receiving the said ultrasound remote “read” signal.

The WSR unit is preferably provided also with an “on/off” switch useful for sparing battery life in long storage conditions of the unit. Switching off WSR devices helps also to reduce the available devices during WSR registration.

The present invention further provides for a simple solution for applications in which a great number of items have to be scanned in a continuum as in warehouse work environment. In such applications the worker using currently available code readers will be forced either to repeatedly press a button on his personal HMC, or on his remote Bluetooth switch, or to shake his hand (activate the said optional tilt sensor) before each code-reading a very inconvenient requirement. Several patent publications deals with trying to solve this problem by using a proximity sensor inside the reader, but those sensors are relatively voluminous (which contradicts a hand wearable miniature device) and are also quite expensive.

The present invention solves the said problem by a device using an HMC software application configured to define a “continuum scanning” regime, in which the first scan is activated conventionally and its successful accomplishment (a recognized machine readable code) triggers the activation of a successive scan, optionally with a predetermined delay of a few seconds between them. The HMC software of the device of the present invention may be configured to stop said continuum scanning cycle once it fails to recognize a code by a recent scan. This may happen due to some mistake in the process, or intentionally by the user which may utilize this function of the device for halting a continuum scanning cycle. A method for continuum scanning is thus being a part of the solution provided by present invention for facilitating code reading work, the method comprises configuring an HMC software application to utilize a successful code reading of one code as a trigger for the activation of a successive scanning.

One of the main benefits of the combined palm-back support and theWSR system of the present invention is that it is a very low cost solution that exploits the wide spread of powerful HMC devices; cellular PDAs, phones, etc., without being affected by the fast changes in their mechanical interface envelopes. The WSR of the present invention thus have the advantage it can work with any new relevant (SRWC and programmable) HMC devices including future ones, without requiring any hardware or mechanical adaptations.

The use of a local (J2ME, Windows CE, Palm OS) client application with built in logic rules for the specific application's tasks and with alerts on forbidden sequences of activities enables continuing to work in adverse wireless connectivity conditions. These offline capabilities make the system appropriate for field work applications, outdoors inspection applications etc.

The WSR device can be a RF tag reader, an optical (e.g. IR) tag reader, a NQR resonance tag, a magnetic tag reader, etc. The optical tag can be an active LED tag or a passive tag as a retro-reflecting tag or any printed two-dimensional code.

The SRWC Bluetooth protocol identifies devices by a set of Universal Unique Identifiers (128 bit UUID). In the preferred embodiment this feature of the Bluetooth protocol is used to assign unique IDs to the Bluetooth enabled WSRs an important feature in tracing devices and workers.

Once the client application is working it will automatically query the Bluetooth port for any available Bluetooth WSR. Bluetooth devices unrelated to the system like cameras, printers will not interfere because the Bluetooth protocol enables a Bluetooth host to query only for specific type of devices (Dedicated Inquiry Access Code, DIAC).

As mentioned above, and in accordance with various embodiments of the wearable palm-back support of the present invention, adjusting mechanisms are provided for adjusting the length of the palm-back support. A loop/s' length adjusting mechanism is provided to allow for modifying the length of the finger loop/s protruding from the support member, thereby adapting it to different hand sizes, to work-glove wearers, and to differences between fingers' circumference of different users. For example by fastening one or both ends of a cord, ribbon, string, or the like which may be used as the material from which the finger loops are formed, and by inserting it through one or more high friction narrowing passages of about 1 cm length in order to semi-dividing it about the middle of its length, and in turn by passing it through a flexible support member body or through one or more Velcro reclosable fastener patch/es fastened to said flexible support member, one can adjust the relative size of said finger loop/s by changing the length of the cord on each side of the said narrowing passage/s, and also change the overall size of the loop/s protruding outside the said flexible support member. By providing said narrow passage within a patch having a Velcro reclosable fastener, the size modification of the loop/s can be made even faster, since changing relative position between the patch and the support member using the Velcro attachment is very simple.

A less aesthetical yet not less efficient method for changing the size of the loops is by just shortening the overall length of the cord/ ribbon by tying it up at one or both ends or between them. The said adjusting mechanism is important for adapting the said wearable support for use of users having different hand sizes or wearing work gloves.

According to the present invention the WSR may further comprise fast attachment mechanism useful for facile replacement of the Slave Reader module connected to the flexible support, e.g. for recharging or e.g. for replacing a malfunctioning unit.

In a preferred embodiment the support is flexible and is built as a single piece including as integral parts a first half connector of the fast attachment mechanism and the adjusting mechanism (not including a second half connector being a counterpart of the first half connector of the fast attachment mechanism, which may be integral to a housing of the Slave Reader module).

Preferably the support member is flexible and includes both fast attachment mechanism and adjusting mechanism.

In an embodiment in which the WSR includes a first half connector of the fast attachment mechanism which may be integral to a housing of the WSR the support member includes a second half connector being a counterpart matching said first half connector built as a part of the flexible support member e.g. by a dual molding manufacturing process or optionally welded to it by ultrasound, glued, riveted, or otherwise integrated to it.

In an alternative preferred embodiment the said fast attachment mechanism is for example a partial pocket-like enclosure integral to the said flexible support member, for accommodating said WSR module. Said partial pocket-like enclosure may comprise an optical window or an opening in its frame providing for a field of view for the WSR reader. The WSR is to be captured inside the pocket by a closing flap with a button or Velcro closure.

The invention relates also to a method for attaching a tool to be used by user to user's hand in a manner allowing the user to selectively use said tool while having his hands free for other work, the method comprising: providing a palm-back support structure configured to be removabaly attacheable to the user's palm, wherein said palm-back support structure is configured to connecting or encasing said tool thereto. Preferably the support structure is removabaly attacheable to the user's palm by inserting at least one of user's fingers into a non-thumb finger-loop of the support structure and by wrapping at least part of the circumference of user's wrist by a wrist strap of the support structure.

### BRIEF DESCRIPTION OF THE FIGS

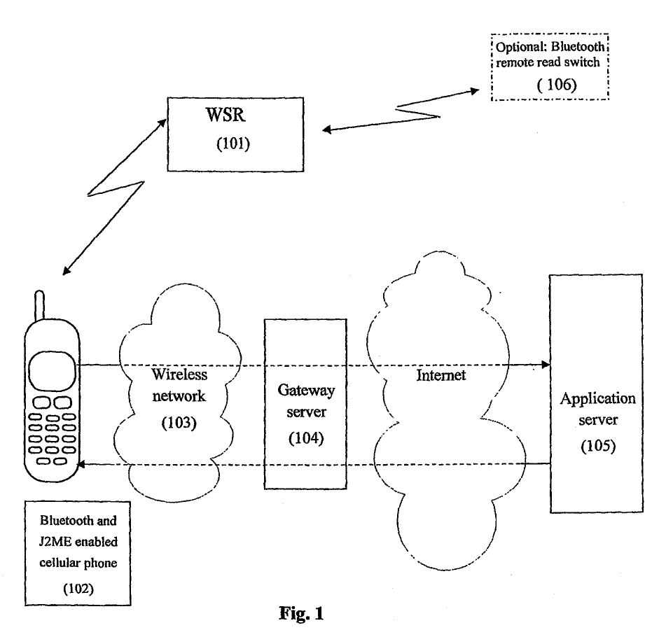

FIG. 1.—Overall system configuration

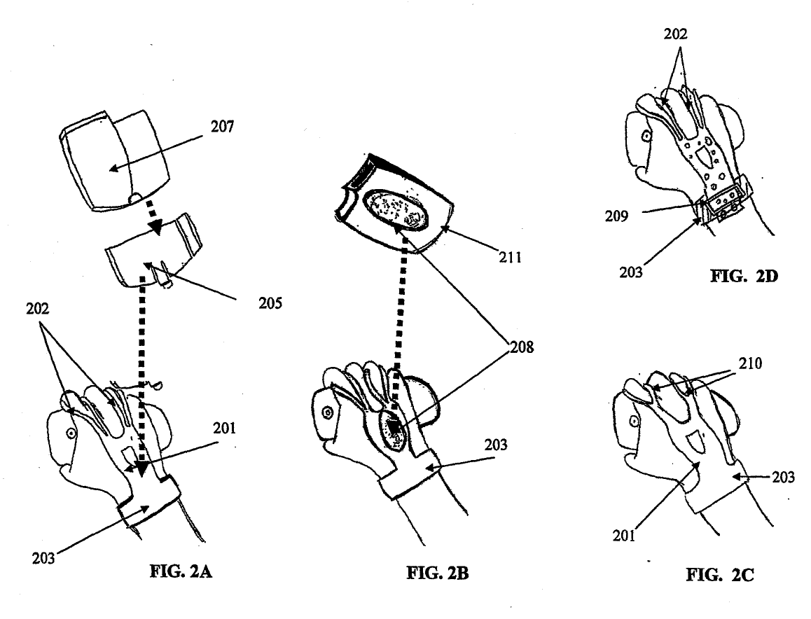

FIGS. 2A-2D—Schematics of the palm-back support and fast attachment mechanisms of one of the preferred embodiments of the present invention

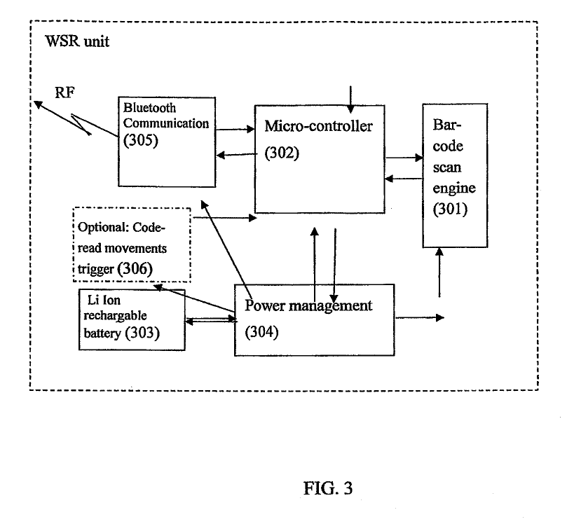

FIG. 3—Block diagram of one of the preferred embodiments of a barcode WSR device

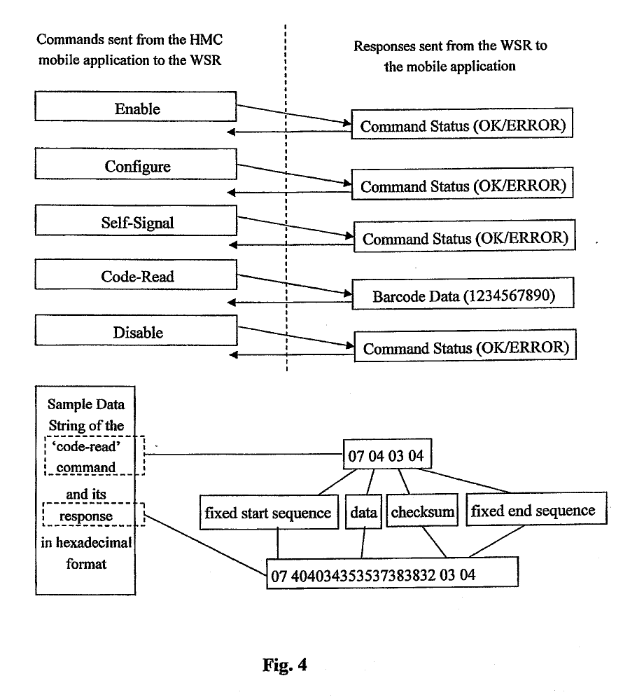

FIG. 4.—Sample Client-Reader interface

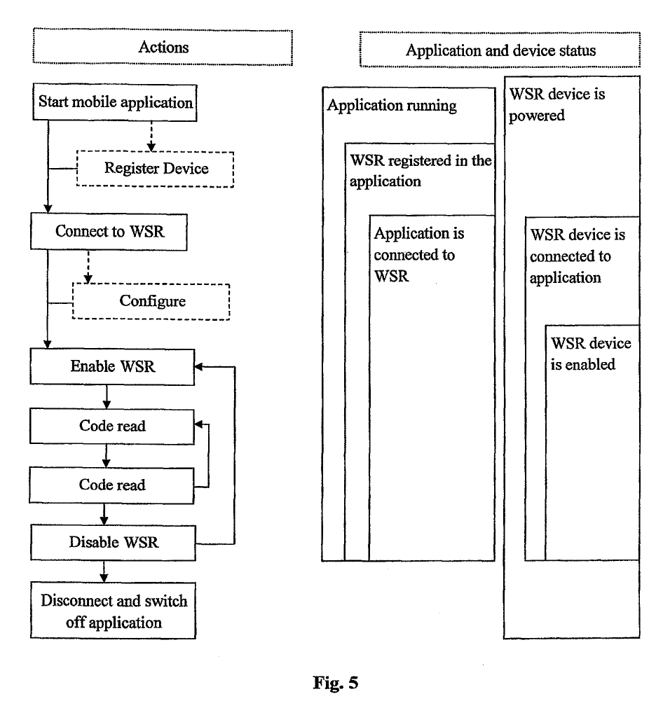

FIG. 5.—Sequence diagram of operation

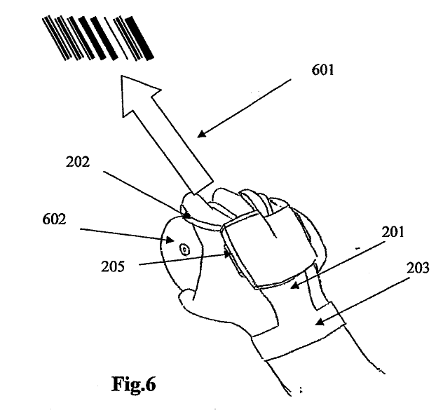

FIG. 6.—The work ergonomics of the WSR and HMC

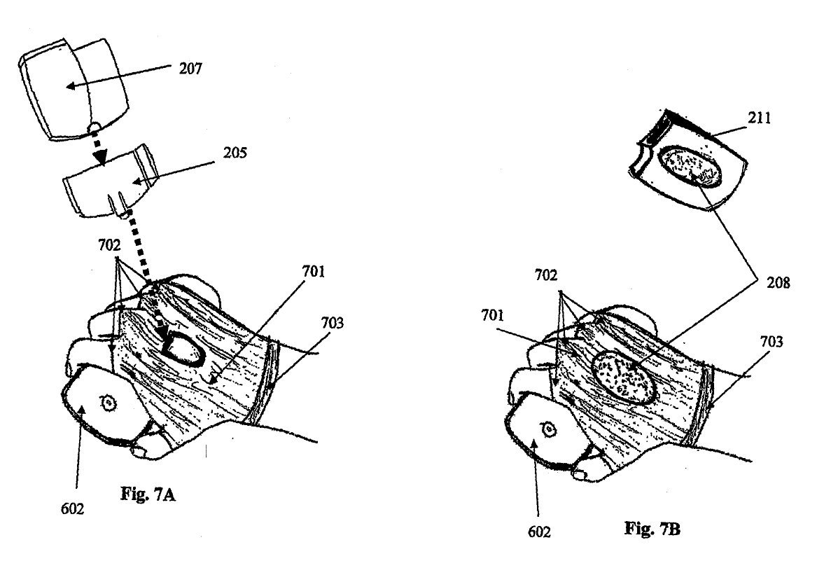

FIGS. 7A-7B—Schematics of the palm-back support and fast attachable mechanics according to other embodiments of the present invention.

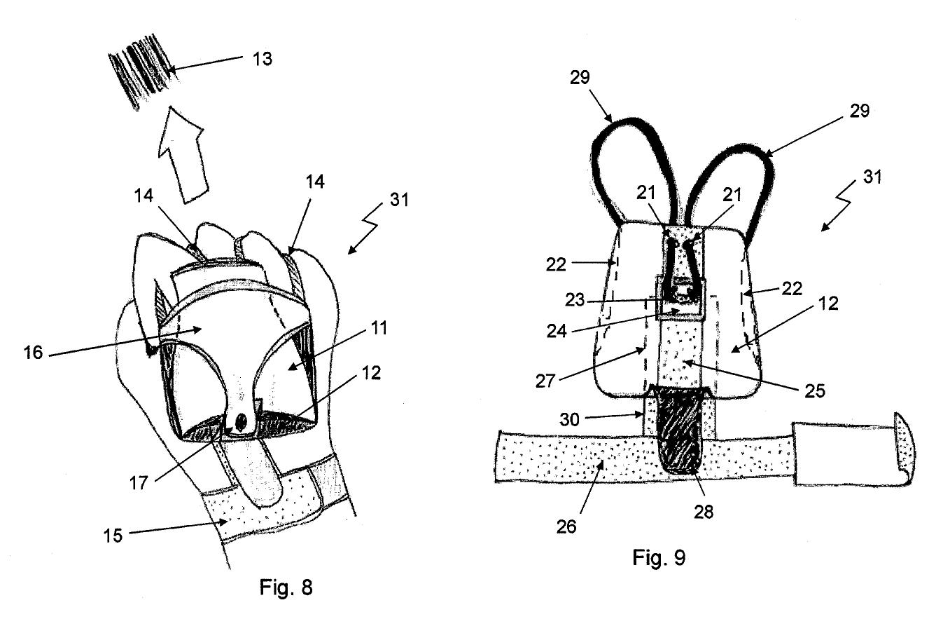

FIG. 8.—The free palm configuration and work ergonomics of the WSR

FIG. 9.—Schematics of the adjusting mechanisms of the palm-back support

### DETAILED DESCRIPTION OF THE FIGURES

The invention is exemplified with reference to the schematic drawings in FIGS. 1-9, which are not according to scale. The invention having been disclosed, variations will now be apparent to persons skilled in the art, the system is described as an example only, not to be construed in a limiting way.

In particular once the concepts of (i) a wireless functional set of minimal electronics forming a wireless slave reader the mechanical shape of which is not restricted by the mechanical shape or the physical or electrical shape of connectors of HMC devices by which it may be controlled, and (ii) fast attachment to a palm back wearable support of the invention having been disclosed, multiple engineering variations will now be apparent to persons skilled in the art, all those engineering solutions being also in the scope of the present invention.

In FIG. 1 we see the general block diagram of the system using Bluetooth SRWC. According to the preferred embodiment a Bluetooth enabled WSR unit (101) is wirelessly communicating with a Bluetooth enabled HMC, a J2ME cellular phone (102) such as the J2ME enabled Nokia 6600 cellular phone or Motorola E398 phone.

The wireless network (103) can be any of the well known types of Wireless WAN networks or cellular networks that support data connectivity like CDPD, GPRS, CDMA 2000, W-CDMA, CDMA 1×, etc. and is connected via a gateway (104) to the Internet.

A server system (105), which is accessible through Internet via communications protocol (e.g. TCP/IP based protocol like HTTP), is responsible for implementing the business logic and data management functions in the system. A client J2ME program residing on the cellular phone provides the user interface for operating the WSR, and the mobile task's functions of the end-user application. The said J2ME client application communicates with the server system via a communications protocol (e.g. HTTP). An end-user application can be any application, which requires mobile data acquisition with verification, mobile data access and mobile process monitoring.

Optionally the code-read trigger to the WSR will be transmitted wirelessly from a Bluetooth enabled, battery operated, stand alone read control switch (106) to be held in user's hand and operated similarly to a remote controller of car alarm. Alternatively, the read control switch may comprise connecting member allowing to maintain it attached to the user's clothes and activated by a touch, e.g. of the free user's hand.

FIGS. 2A-2D illustrate a palm-back support (201) for supporting a tool (207), (211) on the back-side of a user's palm, comprising (i) at least one finger loop member (202) configured to be worn on at least one of non-thumb user's fingers; (ii) a wrist strap (203) configured for wrapping at least partially a user's wrist; (iii) a support member (201) attachable to the backside of the user's palm by means of the finger loops (202) and the wrist strap (203) such that the user's palm (i.e. its inner side which is not shown in the FIGS. ) remains exposed, free of attaching elements in its entirety from the wrist to the base of the fingers. The thumb itself also remains free, with no encircling loop or strap. As can be appreciated, the position and dimensions of the loops (202) and their orientation relative to the wrist strap (203) allow for a comfortable and operative positioning of the support member on the backside of the palm when the loops are worn on non-thumb fingers, with no loop oriented and dimensioned to fit the thumb when the palm back support is in position on the back side of the palm. A palm-back wearable support and fast attachment configurations for e.g. an WSR (207) or (211) are illustrated through the Figs, wherein in a preferred embodiment, FIG. 2A, the WSR (207) comprises a stand-alone wearable palm-back support (201) wearable on the back of a user's palm by its two finger loops (202) worn on two non-thumb fingers and by its wrist strap (203) closed around the user wrist using a common watch-like buckle or equivalent arrangement such as a reclosable Velcro strap e.g. 3M Dual Lock SJ4580. The support (201) comprises a fast attachment bracket interface (205) for fast connecting/ disconnecting the housing (207) of an electronic Slave Reader module, said bracket interface (205) formed by e.g. a dual molding manufacturing process, or optionally may be integrated to the support (201) by e.g. ultrasound welding, gluing, riveting etc., wherein the housing (207) of the electronic Slave Reader module is provided with matching dents for snap fixing it into the said bracket.

The support (201) is a very low cost element that can be manufactured in several lengths sizes in order to fit different hand sizes of different users. Optionally the support (201) may be provided with a length regulating mechanism as depicted in FIG. 2D comprising a buckle (209) located on the wrist strap (203), for adjusting the support's length between the Slave Reader module and the wrist strap. Optionally any other alternative scotch, buttons, etc. means can be used to regulate the length of the flexible support.

Optionally the finger loops of the support (201) may be of different sizes from ring-size (210) that can fit only bare fingers as depicted in FIG. 2C up to elongated loops (202) that can fit any finger size either bare or gloved one, as described in the preferred embodiment illustrated e.g. by FIGS. 2A and 2D.

FIG. 2B depicts an alternative embodiment in which the said fast attachment is achieved by gluing or riveting etc., reclosable fastener patch/es (208), e.g. Velcro fastener, 3M Dual Lock SJ4580, or any fastener capable of providing for a similar result, on the said flexible support and on the said Slave Reader module housing basis (211) to enable a simple fast connecting disconnecting mechanism between the two surfaces.

FIG. 3 presents the structure of a WSR for barcode reading device. All the components presented in the drawing are available from various vendors. The barcode reading element (301) for example the Symbol SE 923HS or the EV15 or EV12 scan engine from Intermec is controlled by the micro controller (302) for example the PIC 18F452 with internal A/D from Microchip, and powered by a Lilon rechargeable battery (303) with built in protection circuit as SPB563452 from Saehan-Enertech. The power management block (304) provides accurate charging, termination and discharge control for the rechargeable battery and further regulates the power for the other blocks in the WSR. The power management block also asserts a reset signal whenever the supply voltage falls below a preset threshold. The SRWC Bluetooth communication block (305), comprise a single module, radio chip and a baseband chip, for example the BlueCore2-Rom or Flash from CSR, or the Vista module from Flextronics with integrated ARM7 core processor. Commands transmitted via the Bluetooth communication protocol from the personal communication device's J2ME client application, are received in the micro-controller which control all the other blocks of the WSR.

Optionally a code-read activate-only trigger sensor circuit (306), for example using a tilt-switch CW 1300-1 from Assentech or a tilt-sensor D6B from Omron, or an acceleration sensor, or the like will be included in the WSR for triggering the code-read operation by a hand movement. The stop-read signal will be provided internally by the WSR's micro-controller (302) after a preset time period of several seconds, the said time will be software programmable.

The WSR unit will also be provided with an “on/off main switch in order to spare battery life in long storage conditions of the unit. Switching off WSR devices will also help reduce the available communicating devices during the WSR registration process.

FIG. 4 presents a basic communication protocol that can be implemented on the base of any transport protocol like Bluetooth.

The basic commands of the protocol that the WSR is required to support by the sample system of the invention are ‘enable’, ‘code-read’, ‘configure’, ‘self-signal’ and ‘disable’. Optionally the WSR device can support additional commands like ‘status’. All of the commands are sent by the client J2ME program and the software defined button of the HMC to the WSR where optionally the command “code-read” can be triggered directly from the said optional code-read activation-only sensor block in the WSR by a hand movement, or transmitted wirelessly from the said Bluetooth enabled, stand alone read control switch.

In order to prevent unwanted code-read operations by unintentionally activating the WSR code-read function, the said client application can send (via the Bluetooth channel) an enabling and disabling command to the WSR by choosing/browsing it from a menu or pressing a software defined button on the said PDA, phone, etc. Once in an “enabled” work session the code-reading trigger of the WSR will be initiated and transmitted by the said client application by pressing a software defined button on the said HMC.
The ‘code-read’ command will trigger the WSR to scan for a barcode according to its algorithm. After the ‘code-read’ procedure has completed successfully the (last) read-result will be sent back.

The ‘self-signal’ command triggers the device to make a visible (and optionally audible) signal that allows the user to recognize it among several similar devices.

Every command is transmitted to the barcode reader in the form of a data string, having the sample structure as depicted in FIG. 4. Every data string consists of fixed start sequence, command data and fixed end sequence. The response data string has similar structure.

FIG. 5 is a sequence diagram of the protocol for controlling the barcode WSR. Through a wireless protocol like Bluetooth the HMC can potentially detect several WSR devices. In order to know which one to connect to the mobile application running on the HMC needs to register the particular WSR that is on the user's hand. The first time the mobile application is run after installation the user will have to register the device by choosing its unique id from a list of available devices. The functions of WSR device query, unique identification, connection and communication are implemented by the underlying transport protocol-Bluetooth.

After the WSR is registered and the mobile application is connected to it the WSR is able to accept ‘enable’, ‘configure’, ‘self-signal’ and ‘status’ commands. The ‘code-read’ command is available only after the mobile application has sent an ‘enable’ command. The user will be able to send ‘code-read’ command either by a software defined button or optionally from the said Bluetooth enabled, stand alone control switch, or optionally by moving his hand and activating the read activation-only sensor of the WSR. The mobile application is able to send a ‘disable’ command in order to deactivate the scan capabilities of the WSR for example when driving between work sites in order not to spend battery on false read commands from unintentional hand movements.

The user will also be able to configure the barcode-reading unit through the user interface of the J2ME client either by inputting the configuration options manually or by requesting a configuration script from the server. When the user is finished working with the system he will be able to deactivate the J2ME client and the WSR unit by sending a ‘deactivate’ command through the J2ME client or by pressing the “off” switch available on the WSR for closing the unit permanently.

FIG. 6, depict the work ergonomic of the WSR when attached to a palm-back support (201) according to the invention: by attaching the said WSR on the palm-back of the user's hand, pointing at the target (601) becomes easy and natural needing no flexing of the wrist.

Preferably the WSR support (201) of the present invention is formed substantially symmetrical, by providing a pair of substantially identical finger loops (202) configured for insertion on two non-thumb fingers, preferably the pointing finger and ring finger (i.e. the finger next to the little finger) and can be worn on both hand palms either bare or gloved hands.

The WSR fingers and wrist support configuration leaves the palm of the user free to perform any work including gripping of objects, tools, etc.

The finger loop (202) of the WSR support can easily be worn over work-gloves of different thicknesses, a feature that cannot be achieved using partial glove like support.

The fast attachment mechanism (205) of the Slave Reader module's housing to the support enables fast replacement of the Slave Reader module for recharging purposes or for replacement of defective unit.

The combination of the WSR of the present invention and the said HMC device (602), together with the said “terminal capabilities” and the dedicated HMC's client application software, enables the user to read codes, input data and receive feedback to the HMC, thus providing him with a powerful “virtual terminal” having capabilities greater than most of the existing cellular/WAN integral terminals and at a fraction of their cost.

FIGS. 7A and 7B depict the schematics of a palm-back support with fast attachable arrangement according to another embodiment. In this embodiment the palm-back support is in the shape of a partial glove. FIG. 7A, illustrates a commercially available partial glove (701) wearable on the user's hand and comprises finger loop members (702) and wrist strap member (703), said partial glove (701) has been modified to comprise a fast attachment bracket interface (205) for fast connecting/disconnecting the housing (207) of an electronic Slave Reader module, said bracket interface (205) to be integrated to the glove (701) by e.g. ultrasound welding, gluing, riveting etc., wherein the housing (207) of the electronic Slave Reader module is provided with matching dents for snap fixing it into the said bracket.

FIG. 7B depicts an embodiment similar to that illustrated by FIG. 7A, with the modification the fast attachment is achieved by gluing or riveting etc., reclosable fastener patch/es (208) as 3M Dual Lock SJ4580, on the commercially available partial glove and on the basis (211) of the Slave Reader module. The fast attachment enables a fast and simple connection and disconnection mechanism between the two parts of the fastener.

FIG. 8 illustrates a ‘free palm’ configuration and a work ergonomic of a WSR (11) attached to a palm-back support (31) according to the present invention. By attaching the WSR (11) to the palm-back of a user's hand, pointing at the target code (13) to be read by the WSR becomes easy, natural, and requiring no uncomfortable flexing of the user's wrist.

Preferably the palm-back support (31) comprises a substantially symmetrical support member (12), from which a pair of finger loops (14) of substantially identical dimensions protrude. The loops are configured for respective insertion on two non-thumb user's fingers, preferably the pointing finger and the ring finger (i.e. the finger next to the small finger) and can be worn on both hand palms either bare or gloved.

The illustrated configuration leaves the inner side of the user's palm free to perform most if not all common work place tasks such as writing, typing, gripping different objects, using and activating tools, etc.

The finger loops (14) of the palm-back support (31) are configured sufficiently wide so they can easily be worn over work-gloves of different thicknesses, a feature that cannot be achieved using partial glove like support. Even though the loops are loosen when wearing in order to allow easy insertion of user's fingers, the palm-back support is held firmly in place on the back of the palm after wearing, since in its operative position the loops are tensed towards the wrist direction. The wrist strap (15) is configured for wrapping the user's wrist and is secured by (scotch) Velcro bands to be closed on themselves, while maintaining the finger loops (14) in tension.

In the exemplified embodiment the fast attachment mechanism between the WSR module (11) and the palm-back support (31) is realized by providing a partial pocket (16) integral to a support member (12) of the palm-back support. The WSR (11) is secured within the partial pocket (16) by a button or a (scotch) Velcro closure provided in a closing flap (17). This arrangement enables for fast replacement of the WSR (11) e.g. for recharging or for replacement with an alternative unit or tool.

FIG. 9 illustrates a palm-back support of the design illustrated in FIG. 1. in a deployed view showing the adjusting mechanisms which facilitate adapting it to different hand sizes. The palm-back support is attachable to the backside of the user's palm by means of the finger loop/s (29) and the wrist strap (26) such that the user's palm remains exposed in its entirety from the wrist to the base of the fingers. In the exemplified embodiment the two finger loops (26) are made by passing a cord (29) through 2 holes (21) into the front part of a flexible support member (12) of the palm-back support, and by further fastening the free ends of the cord (29) in opposite sides (22) of the support member (12), e.g. by stitching. A loops' length adjusting mechanism is thus provided, for modifying each of the loops' length to different hand sizes or glove wearing scenarios and to the difference between different fingers' circumference. is achieved by semi-dividing the cord inside the said support about its middle length by a high friction narrowing passage (23) formed through a (scotch) Velcro reclosable fastener patch (24). The Velcro fastener patch (24) is fastened to a (scotch) contrary Velcro line (25) which is integral to the support member (12). By changing the fastening place of the patch (12) closer to or farther from the front end of the support member (12) of the support, on said (scotch) contrary Velcro line (25), one can easily change the overall size of the loop/s protruding outside from the support member (12). By changing the length of the cord (29) on each side of the said narrowing passage (23) one can easily adjust also the relative size between the finger loops (29) themselves.

A strap's length modifying mechanism is also shown in this FIGURE. It is useful for adjusting the distance between the wrist and the support member (12) of the palm=back support, for adapting it to different hand sizes or glove wearing scenarios. In the exemplified embodiment the length modification is by sliding a semi rigid Velcro (scotch) bearing length-strap (30) within a flat pocket (27) formed in the support member (12). The length-strap (30) forms an integral part with the wrist strap (26). It is therefore understood that sliding the length-strap (30) dipper into the flat pocket (27) will result in shortening the distance between the wrist strap (26) and the support member (12) of the support, and vice versa. Once a desired distance between the wrist strap (26) and the support member (12) has been achieved by sliding the length strap (30) within the flat pocket (27) to a desired position, fixation of the length-strap (30) avoiding further movement of the length-strap (30) within the pocket (27) may easily be achieved by fastening between the Velcro of the length strap (30) and a contrary Velcro flap (28) protruding from the support member (12).

Multiple engineering realizations and variations may become apparent to persons skilled in the art once reading the specification of above with no special talent required, all such engineering solutions should be related as included in the scope of the present invention.

1. Palm-back support for supporting a tool on the back-side of a user's palm, comprising (i) at least one finger loop member configured to be worn on at least one of non-thumb user's fingers; (ii) a wrist strap configured for wrapping at least partially a user's wrist; (iii) a support member attachable to the backside of the user's palm by means of the finger loop and the wrist strap such that the user's palm remains exposed, free of attaching elements in its entirety from the wrist to the base of the fingers.

2. Palm-back support according to claim 1, wherein the support member is a part of a housing of the tool to be supported on the palm's back-side.

3. Palm-back support according to claim 1, wherein the support member comprises a first connector configured to be connectable to a second connector, said second connector being part of or attachable to said tool, thereby enabling to removably attach the tool to the support member by connecting the first and second connectors to each other.

4. Palm-back support according to claim 1, wherein the support member is interconnected between the finger loop and the wrist strap.

5. Palm-back support according to claim 3, wherein the support member is integrally interconnected between the finger loop and the wrist strap.

6. A tool attachable to or constituting a part of the palm-back support according to claim 1.

7. A tool according to claim 6, removably attachable to the support member by connectors.

8. A tool according to claim 6, constituting an electronic device configured for wireless communication with a remote HMC electronic system.

9. A tool according to claim 8, wherein the electronic device is a code reader capable of reading machine readable codes and transmitting data indicative of the read codes to a remote HMC system.

10. A tool according to claim 9, wherein the electronic device is configured for reading of at least one of the following code types: optical, magnetic, RF.

11. A tool according to claim 9, wherein the code reader comprises a tilt sensor or an accelerometer for turning-on in response to a movement.

12. A tool according to claim 8, wherein the electronic device is configured for wireless communication with the remote HMC system via at least one of the following signal transmission types: RF, IR and acoustic signals.

13. A tool according to claim 9, wherein the code reader is passive, constituting a slave governed by the remote HMC system.

14. A tool according to claim 7, said tool and a connector thereof constitute a kit with a separate independent mobile handgrip to which the tool may be removably attached as an alternative to its attachment to the support member.

15. A tool according to claim 10, configured to utilize the accomplishment of a successful code reading for automatically triggering the activation of a successive code scanning.

17. A tool according to claim 10, configured to utilize the accomplishment of a successful code reading for automatically triggering the activation of a successive code scanning, with a programmable or a predetermined delay between successive code scans.

18. A method for continuum scanning of machine readable codes, comprising configuring an HMC software application to utilize a successful code reading of one code as a trigger for the activation of a successive code scanning.

19. Method for attaching a tool to the backside of a user's palm, comprising; providing a palm-back support member for supporting the tool on the backside of the user's palm; providing means for holding a first end of the support member attached to a user's wrist; and providing means for holding a second end of the support member attached to at least one non-thumb user's finger, thereby leaving the users palm free in its entirety between the wrist and the base of the fingers.

20. A tool according to of claim 14, wherein the mobile handgrip comprises an extension facilitating reaching-out the tool for reading remotely located codes.

21. A tool according to of claim 20, wherein the extension is telescoping.

22. Palm-back support for supporting a tool on the back-side of a user's palm according to claim 1, comprising a mechanism for adjusting the length of the at least one finger loop thereby improving adaptation to different sizes of wearers' hands.

23. Palm-back support for supporting a tool on the back-side of a user's palm according to claim 1, comprising a mechanism for adjusting the distance between the wrist strap and the support member, thereby improving adaptation to different sizes of wearers' hands.

24. Palm-back support according to claim 1, wherein the support member comprises a pouch configured to removably accommodate the tool in an operative position on the back of the palm.
